(19) United States
(12) Patent Application Publication
(10) Pub. No.: US 2022/0050238 A1
(43) Pub. Date: Feb. 17, 2022

(54) FABRY-PEROT INTERFERENCE FILTER

(71) Applicant: HAMAMATSU PHOTONICS K.K., Hamamatsu-shi, Shizuoka (JP)

(72) Inventors: Takashi KASAHARA, Hamamatsu-shi, Shizuoka (JP); Katsumi SHIBAYAMA, Hamamatsu-shi, Shizuoka (JP); Masaki HIROSE, Hamamatsu-shi, Shizuoka (JP); Hiroki OYAMA, Hamamatsu-shi, Shizuoka (JP); Yumi KURAMOTO, Hamamatsu-shi, Shizuoka (JP)

(73) Assignee: HAMAMATSU PHOTONICS K.K., Hamamatsu-shi, Shizuoka (JP)

(21) Appl. No.: 17/278,910

(22) PCT Filed: Sep. 24, 2019
(86) PCT No.: PCT/JP2019/037349

§ 371 Date: Mar. 23, 2021

(30) Foreign Application Priority Data
Oct. 3, 2018 (JP) 2018-188349

(51) Int. Cl. G02B 5/28; G02B 26/00

(52) U.S. Cl. CPC G02B 5/284; G02B 26/001

(57) ABSTRACT

A Fabry-Perot interference filter includes: a substrate; a first laminated body including a first mirror portion; a second laminated body including a second mirror portion; an intermediate layer including a defining portion that defines the gap between the first laminated body and the second laminated body; a first electrode formed in a first layer constituting the first laminated body; and a second electrode formed in a second layer constituting the second laminated body. The intermediate layer further includes a covering portion that covers outer edges of a plurality of layers including the first layer among layers constituting the first laminated body; and an extending portion that extends outward from the covering portion. The second laminated body extends to cover a stepped surface formed between the defining portion and the extending portion by the covering portion and an outer end surface of the extending portion.

### TECHNICAL FIELD

One aspect of the present disclosure relates to a Fabry-Perot interference filter.

### BACKGROUND ART

A Fabry-Perot interference filter is known that includes a substrate, a first laminated body including a first mirror portion disposed on the substrate, a second laminated body including a second mirror portion facing the first mirror portion with a gap interposed therebetween, and an intermediate layer that defines a gap between the first laminated body and the second laminated body (for example, refer to Patent Literature 1). In the Fabry-Perot interference filter described in Patent Literature 1, the outer edges of the first laminated body, the second laminated body, and the intermediate layer match each other when viewed from the stacking direction.

### CITATION LIST

### Patent Literature

Patent Literature 1: Japanese Unexamined Patent Publication No. 2013-257561

### SUMMARY OF INVENTION

### Technical Problem

In the Fabry-Perot interference filter described above, for example, in order to suppress the peeling of the first laminated body and the intermediate layer, it is conceivable to extend the second laminated body outward so that the outer edges of the first laminated body and the intermediate layer are covered by the second laminated body. In this case, however, since the first laminated body and the second laminated body come into contact with each other at the covering position, current leakage may occur between a driving electrode formed in the first laminated body and a driving electrode formed in the second laminated body. In addition, the Fabry-Perot interference filter described above is required to have improved manufacturing stability.

One aspect of the present disclosure is to provide a Fabry-Perot interference filter capable of suppressing current leakage and improving manufacturing stability while suppressing the peeling of each layer on a substrate.

### Solution to Problem

A Fabry-Perot interference filter according to one aspect of the present disclosure includes: a substrate including a first surface; a first laminated body including a first mirror portion disposed on the first surface; a second laminated body including a second mirror portion that faces the first mirror portion with a gap interposed therebetween on a side opposite to the substrate with respect to the first mirror portion; an intermediate layer including a defining portion that defines the gap between the first laminated body and the second laminated body; a first electrode formed in a first layer constituting the first laminated body; and a second electrode that is formed in a second layer constituting the second laminated body and faces the first electrode. The intermediate layer further includes: a covering portion that covers outer edges of a plurality of layers including the first layer among layers constituting the first laminated body; and an extending portion that extends outward from the covering portion along a direction parallel to the first surface. The second laminated body extends to cover a stepped surface formed between the defining portion and the extending portion by the covering portion and an outer end surface of the extending portion.

In the Fabry-Perot interference filter, the outer end surface of the intermediate layer (more specifically, the outer end surface of the extending portion) is covered by the second laminated body. Therefore, peeling of the intermediate layer can be suppressed. In addition, the outer edges of a plurality of layers including the first layer in which the first electrode is formed, among the layers constituting the first laminated body, are covered by the covering portion of the intermediate layer. Therefore, since electrical insulation between the first layer in the first laminated body and the second layer in which the second electrode is formed in the second laminated body can be improved, it is possible to suppress current leakage occurring between the first electrode and the second electrode through the first layer and the second layer. In particular, since not only the first layer but also the outer edges of the plurality of layers including the first layer are covered by the covering portion, current leakage can be suppressed more reliably. In addition, the intermediate layer has an extending portion that extends outward from the covering portion along the direction parallel to the first surface of the substrate, and the second laminated body extends to cover the stepped surface formed between the defining portion and the extending portion by the covering portion and the outer end surface of the extending portion. Therefore, the step formed in the second laminated body can be made gentler than in a case where the intermediate layer does not have the extending portion. By making the step formed in the second laminated body gentle, for example, it is possible to suppress the occurrence of application unevenness when applying the resist for etching. As a result, it is possible to improve the manufacturing stability. Therefore, according to the Fabry-Perot interference filter, it is possible to suppress current leakage and improve the manufacturing stability while suppressing the peeling of each layer on the substrate.

The Fabry-Perot interference filter according to one aspect of the present disclosure may further include: a third electrode that is formed in the first laminated body and faces the second electrode; and a wiring portion that is formed in a third layer constituting the first laminated body and is electrically connected to the second electrode and the third electrode, and the covering portion may further cover an outer edge of the third layer. In this case, since the third electrode has the same potential as the second electrode, the first mirror portion and the second mirror portion can be kept flat at the time of driving. In addition, since the outer edge of the third layer is covered by the covering portion, current leakage can be suppressed even more reliably.

The covering portion may cover outer edges of all layers constituting the first laminated body. In this case, current leakage can be suppressed even more reliably. In addition, since the outer edges of all the layers constituting the first laminated body are covered by the intermediate layer and the outer edges of the intermediate layer are covered by the second laminated body, the peeling of the first laminated body can be suitably suppressed.

A width of the extending portion may be larger than a thickness of the defining portion. In this case, a large width of the extending portion can be secured. As a result, it is possible to suitably suppress the peeling of each layer on the substrate and to suitably make a step formed in the second laminated body gentle.

The stepped surface may extend to be inclined with respect to the first surface, and a width of the extending portion may be larger than a width of the stepped surface. In this case, it is possible to increase the distance between a portion of the second laminated body that covers the stepped surface and a portion that covers the outer end surface of the extending portion. As a result, the step formed in the second laminated body can be made gentle more suitably, and the manufacturing stability can be further improved. In addition, the width of the extending portion can be secured larger, and as a result, the peeling of each layer on the substrate can be more suitably suppressed.

The stepped surface may be a curved surface. In this case, since the surface of the portion of the second laminated body that covers the stepped surface becomes smoother, the manufacturing stability can be further improved.

The stepped surface may be curved in a convex shape. In this case, since the surface of the portion of the second laminated body that covers the stepped surface becomes even smoother, the manufacturing stability can be further improved.

An outer end surface of the first laminated body may be curved in a convex shape. In this case, since the surface of the portion of the second laminated body that covers the stepped surface becomes even smoother, the manufacturing stability can be further improved.

The second layer may be a layer in contact with the intermediate layer among layers constituting the second laminated body. When the second layer is a layer in contact with the intermediate layer, the distance between the first layer and the second layer is short. According to the Fabry-Perot interference filter of the present invention, even in such a case, it is possible to suitably suppress the occurrence of current leakage.

### Advantageous Effects of Invention

According to one aspect of the present disclosure, it is possible to provide a Fabry-Perot interference filter capable of suppressing current leakage and improving manufacturing stability while suppressing the peeling of each layer on the substrate.

### BRIEF DESCRIPTION OF DRAWINGS

FIG. 1 is a plan view of a Fabry-Perot interference filter.

FIG. 2 is a bottom view of a Fabry-Perot interference filter.

FIG. 3 is a cross-sectional view taken along the line III-III of FIG. 1.

FIG. 4 is an enlarged cross-sectional view illustrating a part of the Fabry-Perot interference filter.

FIG. 5 is a cross-sectional view of a Fabry-Perot interference filter of a first modification example.

FIG. 6 is a cross-sectional view of a Fabry-Perot interference filter of a second modification example.

### DESCRIPTION OF EMBODIMENTS

Hereinafter, an embodiment of the present disclosure will be described in detail with reference to the diagrams. In addition, in the following description, the same or equivalent elements are denoted by the same reference numerals, and repeated description thereof will be omitted.

### [Configuration of Fabry-Perot Interference Filter]

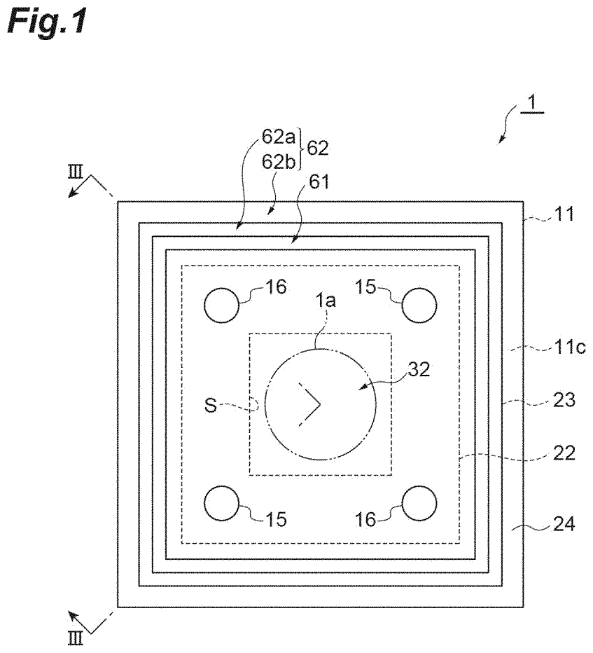

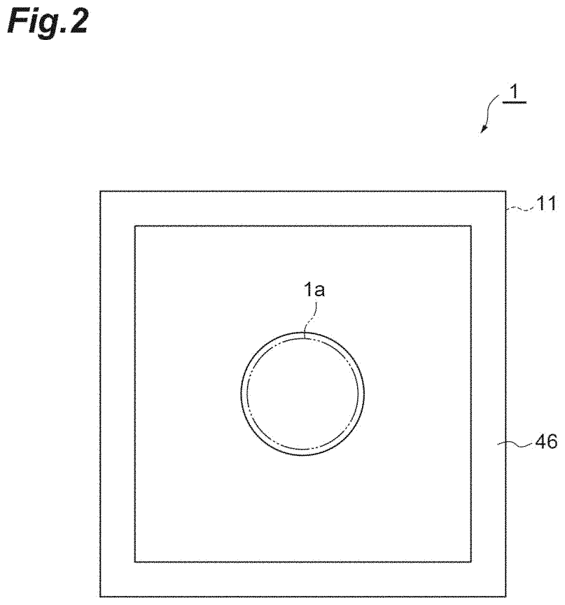

As illustrated in FIGS. 1 to 3, a Fabry-Perot interference filter 1 includes a substrate 11. The substrate 11 has a first surface 11a and a second surface 11b on a side opposite to the first surface 11a. An antireflection layer 21, a first laminated body 22, an intermediate layer 23, and a second laminated body 24 are laminated in this order on the first surface 11a. Between the first laminated body 22 and the second laminated body 24, a gap (in other words, an air gap) S is defined by the frame-shaped intermediate layer 23.

The shape and positional relationship of each portion when viewed from a direction perpendicular to the first surface 11a (in other words, in a plan view) are as follows. The outer edge of the substrate 11 has, for example, a rectangular shape having a side length of about several hundred μm to several tens of mm. The outer edges of the substrate 11 and the second laminated body 24 match each other. The outer edges of the antireflection layer 21 and the first laminated body 22 match each other. The outer edge of the intermediate layer 23 is located further outward (in other words, on a side opposite to the center of the gap S) than the outer edges of the antireflection layer 21 and the first laminated body 22 and further inward (in other words, on the center side of the gap S) than the outer edges of the substrate 11 and the second laminated body 24. That is, the substrate 11 has an outer edge portion 11c located further outward than the outer edge of the intermediate layer 23. The outer edge portion 11c has, for example, a frame shape, and surrounds the intermediate layer 23 when viewed from a direction perpendicular to the first surface 11a. The gap S has, for example, a circular shape. The outer edge of the antireflection layer 21 may be located further outward than the outer edge of the intermediate layer 23, or the outer edge of the antireflection layer 21 and the outer edge of the intermediate layer 23 may match each other. The antireflection layer 21 and the intermediate layer 23 may be integrally formed.

The Fabry-Perot interference filter 1 allows light having a predetermined wavelength to be transmitted through a light transmissive region 1a defined in its central portion. The light transmissive region 1a is, for example, a columnar region. The substrate 11 is formed of, for example, silicon, quartz, or glass. When the substrate 11 is formed of silicon, the antireflection layer 21 and the intermediate layer 23 are formed of, for example, silicon oxide. The intermediate layer 23 has an insulation property. The thickness of the intermediate layer 23 is, for example, several tens of nm to several tens of μm.

A portion of the first laminated body 22 corresponding to the light transmissive region 1a (for example, a portion overlapping the gap S in a plan view) functions as a first mirror portion 31. The first mirror portion 31 is a fixed mirror. The first mirror portion 31 is disposed on the first surface 11a with the antireflection layer 21 interposed therebetween. The first laminated body 22 is formed, for example, by alternately laminating a plurality of polysilicon layers 25 and a plurality of silicon nitride layers 26 one by one. In the Fabry-Perot interference filter 1, a polysilicon layer 25a, a silicon nitride layer 26a, a polysilicon layer 25b, a silicon nitride layer 26b, and a polysilicon layer 25c are laminated on the antireflection layer 21 in this order. The optical thickness of each of the polysilicon layers 25 and the silicon nitride layers 26 constituting the first mirror portion 31 is preferably an integral multiple of ¼ of the central transmission wavelength. The first mirror portion 31 may be disposed directly on the first surface 11a without the antireflection layer 21 interposed therebetween.

A portion of the second laminated body 24 corresponding to the light transmissive region 1a (for example, a portion overlapping the gap S in a plan view) functions as a second mirror portion 32. The second mirror portion 32 is a movable mirror. The second mirror portion 32 faces the first mirror portion 31 with the gap S interposed therebetween on a side opposite to the substrate 11 with respect to the first mirror portion 31. The direction in which the first mirror portion 31 and the second mirror portion 32 face each other is parallel to the direction perpendicular to the first surface 11a. The second laminated body 24 is disposed on the first surface 11a with the antireflection layer 21, the first laminated body 22, and the intermediate layer 23 interposed therebetween. The second laminated body 24 is formed, for example, by alternately laminating a plurality of polysilicon layers 27 and a plurality of silicon nitride layers 28 one by one. In the Fabry-Perot interference filter 1, a polysilicon layer 27a, a silicon nitride layer 28a, a polysilicon layer 27b, a silicon nitride layer 28b, and a polysilicon layer 27c are laminated on the intermediate layer 23 in this order. The optical thickness of each of the polysilicon layers 27 and the silicon nitride layers 28 constituting the second mirror portion 32 is preferably an integral multiple of ¼ of the central transmission wavelength.

In the first laminated body 22 and the second laminated body 24, a silicon oxide layer may be used instead of the silicon nitride layer. As materials of each layer constituting the first laminated body 22 and the second laminated body 24, titanium oxide, tantalum oxide, zirconium oxide, magnesium fluoride, aluminum oxide, calcium fluoride, silicon, germanium, zinc sulfide, and the like may be used.

A plurality of through holes (not illustrated) are formed in a portion of the second laminated body 24 corresponding to the gap S (for example, a portion overlapping the gap S in a plan view). The through holes extend from a surface 24a of the second laminated body 24 not facing the intermediate layer 23 to the gap S. The through holes are formed to such an extent that the through holes do not substantially affect the function of the second mirror portion 32. The through holes are used, for example, to form the gap S by removing a part of the intermediate layer 23 by etching.

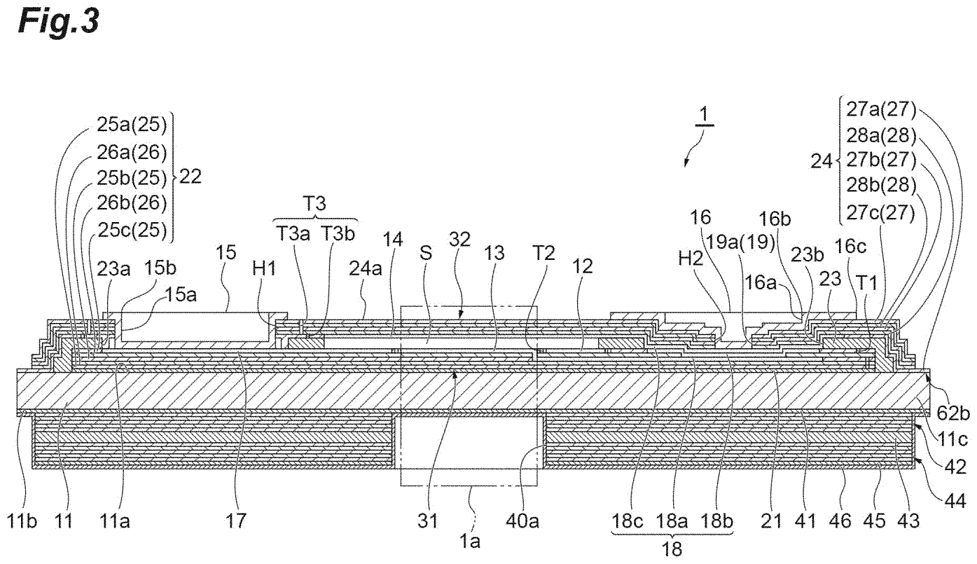

As illustrated in FIG. 3, a driving electrode (first electrode) 12 and a compensation electrode (third electrode) 13 are provided in the first mirror portion 31. The driving electrode 12 has, for example, an annular shape and surrounds the light transmissive region 1a in a plan view. For example, the driving electrode 12 is formed in the polysilicon layer 25c (first layer) constituting the first laminated body 22. The polysilicon layer 25c is a layer in contact with the intermediate layer 23 among the layers constituting the first laminated body 22, in other words, a layer located on the farthest side from the substrate 11. The driving electrode 12 is formed, for example, by doping the polysilicon layer 25c with impurities to reduce the resistance.

The compensation electrode 13 has, for example, a circular shape and overlaps the light transmissive region 1a in a plan view. The size of the compensation electrode 13 may be a size including the entire light transmissive region 1a, but may be approximately the same as the size of the light transmissive region 1a. The compensation electrode 13 is formed in the polysilicon layer 25c in which the driving electrode 12 is formed. The compensation electrode 13 is formed, for example, by doping the polysilicon layer 25c with impurities to reduce the resistance.

A driving electrode (second electrode) 14 is provided in the second mirror portion 32. The driving electrode 14 has, for example, a circular shape in a plan view, and faces the driving electrode 12 and the compensation electrode 13 with the gap S interposed therebetween. For example, the driving electrode 14 is formed in the polysilicon layer 27a (second layer) constituting the second laminated body 24. The polysilicon layer 27a is a layer in contact with the intermediate layer 23 among the layers constituting the second laminated body 24, in other words, a layer located closest to the substrate 11. The driving electrode 14 is formed, for example, by doping the polysilicon layer 27a with impurities to reduce the resistance.

The Fabry-Perot interference filter 1 further includes a pair of terminals 15 and a pair of terminals 16. The terminals 15 and 16 are provided outward of the light transmissive region 1a in a plan view. The terminals 15 and 16 are formed of, for example, a metal film such as aluminum or an alloy thereof. The terminals 15 face each other with the light transmissive region 1a interposed therebetween, and the terminals 16 face each other with the light transmissive region 1a interposed therebetween. The direction in which the terminals 15 face each other is perpendicular to the direction in which the terminals 16 face each other (refer to FIG. 1).

The terminal 15 is disposed in a through hole H1 extending from the surface 24a of the second laminated body 24 to the first laminated body 22. The terminal 15 is electrically connected to the driving electrode 12 through a wiring portion 17. The wiring portion 17 is formed in the polysilicon layer 25c. The wiring portion 17 is formed, for example, by doping the polysilicon layer 25c with impurities to reduce the resistance. The terminal 15 has an opening 15a that is open on a side opposite to the substrate 11. The intermediate layer 23 has an inner side surface 23a that defines the through hole H1. An opening edge 15b of the opening 15a is located further inward than the inner side surface 23a over the entire circumference (in other words, at any position on the opening edge 15b) in a plan view.

The terminal 16 is disposed in a through hole H2 extending from the surface 24a of the second laminated body 24 to the inside of the intermediate layer 23. The terminal 16 is electrically connected to the compensation electrode 13 and the driving electrode 14 through a wiring portion 18. Therefore, when the Fabry-Perot interference filter 1 is driven, the compensation electrode 13 has the same potential as the driving electrode 14. The wiring portion 18 has, for example, a wiring portion 18a formed in the polysilicon layer 25b (third layer), a wiring portion 18b formed in the polysilicon layer 25c, and a wiring portion 18c formed in the polysilicon layer 27a. The wiring portion 18a is electrically connected to the compensation electrode 13, and the wiring portion 18c is electrically connected to the driving electrode 14. The wiring portion 18b is in contact with the wiring portions 18a and 18c, and the wiring portions 18a to 18c are electrically connected to each other. Each of the wiring portions 18a to 18c is formed, for example, by doping the polysilicon layer 25b, 25c, or 27a with impurities to reduce the resistance. The terminal 16 has an opening 16a that is open on a side opposite to the substrate 11. The intermediate layer 23 has an inner side surface 23b that defines the through hole H2. An opening edge 16b of the opening 16a is located further inward than the inner side surface 23b over the entire circumference (in other words, at any position on the opening edge 16b) in a plan view. The outer edge 16c of the terminal 16 is located further outward than the inner side surface 23b over the entire circumference in a plan view.

A trench T1 and a trench T2 are provided in the first laminated body 22. The trench T1 is formed in the polysilicon layer 25c, and extends in an annular shape to surround a portion of the wiring portion 18 connected to the terminal 16. The trench T1 electrically insulates the driving electrode 12 and the wiring portion 18 from each other. The trench T2 is formed in the polysilicon layer 25c, and extends in an annular shape along the boundary between the driving electrode 12 and the compensation electrode 13. The trench T2 electrically insulates the driving electrode 12 from a region (that is, the compensation electrode 13) located further inward than the driving electrode 12. The driving electrode 12 and the compensation electrode 13 are electrically insulated from each other by the trenches T1 and T2. The region in each of the trenches T1 and T2 may be an insulating material or may be an air gap.

A trench T3 is provided in the second laminated body 24. The trench T3 has a first portion T3a and a second portion T3b. The first portion T3a is continuously formed in the polysilicon layers 27b and 27c and the silicon nitride layers 28a and 28b, and extends in an annular shape to surround the terminal 15. The second portion T3b is formed in the polysilicon layer 27a, and extends in an annular shape to surround the terminal 15. The second portion T3b is separated from the first portion T3a. The second portion T3b is located further outward than the first portion T3a over the entire circumference in a plan view. The trench T3 electrically insulates the terminal 15 from the driving electrode 14. The region in the trench T3 may be an insulating material or may be a gap.

An antireflection layer 41, a third laminated body 42, an intermediate layer 43, and a fourth laminated body 44 are laminated in this order on the second surface 11b of the substrate 11. The antireflection layer 41 and the intermediate layer 43 have the same configurations as the antireflection layer 21 and the intermediate layer 23, respectively. The third laminated body 42 and the fourth laminated body 44 each have a laminated structure symmetrical with respect to the first laminated body 22 and the second laminated body 24 with the substrate 11 as a reference. The antireflection layer 41, the third laminated body 42, the intermediate layer 43, and the fourth laminated body 44 have a function of suppressing the warpage of the substrate 11.

The third laminated body 42, the intermediate layer 43, and the fourth laminated body 44 are made thin along the outer edge of the outer edge portion 11c. That is, portions of the third laminated body 42, the intermediate layer 43, and the fourth laminated body 44 along the outer edge of the outer edge portion 11c are thinner than the other portions of the third laminated body 42, the intermediate layer 43, and the fourth laminated body 44 excluding the portions along the outer edge. In the Fabry-Perot interference filter 1, the third laminated body 42, the intermediate layer 43, and the fourth laminated body 44 are made thin by removing all of the third laminated body 42, the intermediate layer 43, and the fourth laminated body 44 at a portion overlapping a thinned portion 62b, which will be described later, in a plan view.

An opening 40a is provided in the third laminated body 42, the intermediate layer 43, and the fourth laminated body 44 to overlap the light transmissive region 1a in a plan view. The opening 40a has a diameter approximately the same as the size of the light transmissive region 1a. The opening 40a is open on the light emitting side. The bottom surface of the opening 40a reaches the antireflection layer 41.

A light shielding layer 45 is formed on the surface of the fourth laminated body 44 on the light emitting side. The light shielding layer 45 is formed of a metal film, such as aluminum or an alloy thereof. A protective layer 46 is formed on the surface of the light shielding layer 45 and the inner surface of the opening 40a. The protective layer 46 covers the outer edges of the third laminated body 42, the intermediate layer 43, the fourth laminated body 44, and the light shielding layer 45, and also covers the antireflection layer 41 on the outer edge portion 11c. The protective layer 46 is formed of, for example, aluminum oxide. In addition, by setting the thickness of the protective layer 46 to 1 nm to 100 nm (preferably, about 30 nm), the optical influence of the protective layer 46 can be ignored.

In the Fabry-Perot interference filter 1 configured as described above, when a voltage is applied between the driving electrodes 12 and 14 through the terminals 15 and 16, an electrostatic force corresponding to the voltage is generated between the driving electrodes 12 and 14. The second mirror portion 32 is attracted to the side of the first mirror portion 31 fixed to the substrate 11 by the electrostatic force, so that the distance between the first mirror portion 31 and the second mirror portion 32 is adjusted. As described above, in the Fabry-Perot interference filter 1, the distance between the first mirror portion 31 and the second mirror portion 32 is variable.

The wavelength of light transmitted through the Fabry-Perot interference filter 1 depends on the distance between the first mirror portion 31 and the second mirror portion 32 in the light transmissive region 1a. Therefore, the wavelength of transmitted light can be appropriately selected by adjusting the voltage applied between the driving electrodes 12 and 14. Here, the compensation electrode 13 has the same potential as the driving electrode 14. Therefore, the compensation electrode 13 functions to keep the first mirror portion 31 and the second mirror portion 32 flat in the light transmissive region 1a.

In the Fabry-Perot interference filter 1, a spectroscopic spectrum can be obtained by detecting light transmitted through the light transmissive region 1a of the Fabry-Perot interference filter 1 using a photodetector while changing the voltage applied to the Fabry-Perot interference filter 1 (that is, changing the distance between the first mirror portion 31 and the second mirror portion 32), for example.

### [Detailed Configuration of Each Portion]

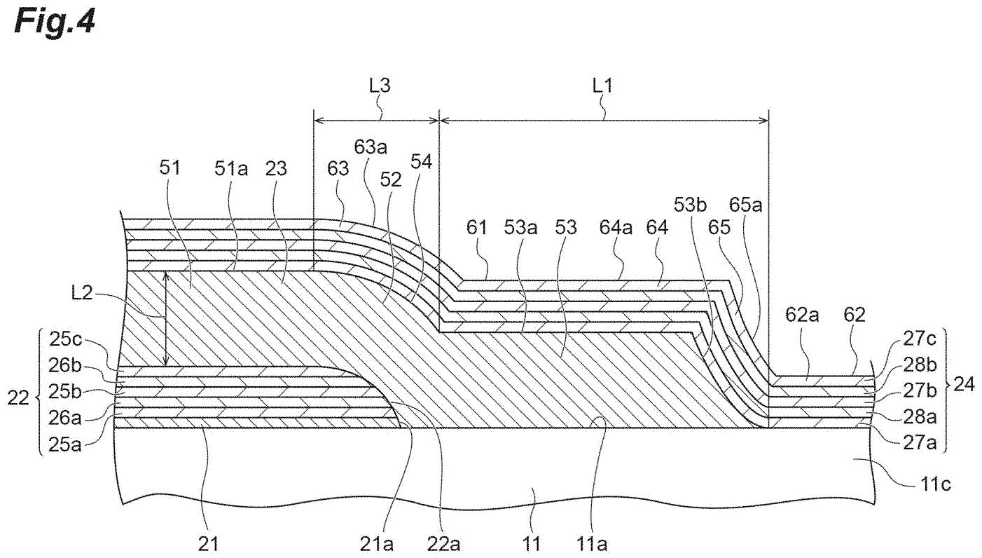

FIG. 4 is an enlarged cross-sectional view illustrating a part of the Fabry-Perot interference filter 1. The shape of each portion is schematically illustrated in FIG. 3, but actually, each portion has a shape illustrated in FIG. 4. As illustrated in FIG. 4, an outer end surface 22a of the first laminated body 22 is a curved surface that is curved in a convex shape. The outer end surface 22a extends to be inclined with respect to the first surface 11a, so as to go farther away from the gap S in the direction parallel to the first surface 11a as going closer to the substrate 11 in the direction perpendicular to the first surface 11a. The outer end surface 22a does not necessarily have to be a smooth curved surface, and may have a fine step formed by the outer edges of the polysilicon layers 25a, 25b, and 25c and the silicon nitride layers 26a and 26b. Even in this case, the outer end surface 22a can be formed in a convexly curved shape as a whole.

The intermediate layer 23 has a defining portion 51, a covering portion 52, and an extending portion 53. The defining portion 51, the covering portion 52, and the extending portion 53 are integrally formed to be continuous with each other. The defining portion 51 defines the gap S between the first laminated body 22 and the second laminated body 24. The defining portion 51 overlaps the first laminated body 22 and the second laminated body 24 in a plan view.

The covering portion 52 surrounds the defining portion 51 in a plan view. The covering portion 52 has, for example, a rectangular frame shape in a plan view. The covering portion 52 covers the outer end surface 21a of the antireflection layer 21 and the outer end surface 22a of the first laminated body 22, and extends to the first surface 11a. That is, the covering portion 52 covers the outer edges of all the layers constituting the first laminated body 22, that is, the outer edges of the polysilicon layers 25a, 25b, and 25c and the silicon nitride layers 26a and 26b.

The extending portion 53 surrounds the covering portion 52 in a plan view. The extending portion 53 has, for example, a rectangular frame shape in a plan view. The extending portion 53 extends from the covering portion 52 to the outside (in other words, a side opposite to the center of the gap S) along the direction parallel to the first surface 11a. Between the defining portion 51 and the extending portion 53, a stepped surface 54 is formed by the covering portion 52. The stepped surface 54 is connected to a surface 51a of the defining portion 51 on a side opposite to the substrate 11 and a surface 53a of the extending portion 53 on a side opposite to the substrate 11. The surfaces 51a and 53a are parallel to each other and extend along a direction parallel to the first surface 11a, for example. The distance from the surface 51a to the first surface 11a is longer than the distance from the surface 53a to the first surface 11a.

The stepped surface 54 has a shape along the outer end surface 22a of the first laminated body 22, and is a curved surface that is curved in a convex shape. The stepped surface 54 extends to be inclined with respect to the first surface 11a, so as to go farther away from the gap S in the direction parallel to the first surface 11a as going closer to the substrate 11 in the direction perpendicular to the first surface 11a. An outer end surface 53b of the extending portion 53 is a curved surface that is curved in a concave shape. The outer end surface 53b extends to be inclined with respect to the first surface 11a, so as to go farther away from the gap S in the direction parallel to the first surface 11a as going closer to the substrate 11 in the direction perpendicular to the first surface 11a.

The width L1 of the extending portion 53 is larger than the thickness L2 of the defining portion 51. The width L1 of the extending portion 53 is larger than the width L3 of the stepped surface 54. The width L1 of the extending portion 53 is the length of the extending portion 53 along the extending direction of the extending portion 53 (in this example, a direction from the center of the substrate 11 toward the outer edge). The thickness L2 of the defining portion 51 is the length of the defining portion 51 along the direction perpendicular to the first surface 11a. The width L3 of the stepped surface 54 is the length of the stepped surface 54 along the extending direction of the extending portion 53.

The second laminated body 24 has a covering portion 61 and a peripheral edge portion 62 in addition to the second mirror portion 32. The second mirror portion 32, the covering portion 61, and the peripheral edge portion 62 are integrally formed to have a part of the same laminated structure and to be continuous with each other. The second laminated body 24 extends to the outer edge of the substrate 11 so as to cover the stepped surface 54 formed between the defining portion 51 and the extending portion 53 by the covering portion 52 and the outer end surface 53b of the extending portion 53.

The covering portion 61 surrounds the second mirror portion 32 in a plan view. The covering portion 61 has, for example, a rectangular frame shape in a plan view. The covering portion 61 includes a first portion 63 that covers the stepped surface 54, a second portion 64 that covers the surface 53a of the extending portion 53, and a third portion 65 that covers the outer end surface 53b of the extending portion 53. The first portion 63, the second portion 64, and the third portion 65 are integrally formed to be continuous with each other.

A surface 63a of the first portion 63 on a side opposite to the substrate 11 has a shape along the stepped surface 54, and is a curved surface that is curved in a convex shape. A surface 64a of the second portion 64 on a side opposite to the substrate 11 has a shape along the surface 53a, and is a flat surface parallel to the first surface 11a. A surface 65a of the third portion 65 on a side opposite to the substrate 11 has a shape along the outer end surface 53b, and is a curved surface that is curved in a concave shape.

The peripheral edge portion 62 surrounds the covering portion 61 in a plan view. The peripheral edge portion 62 has, for example, a rectangular frame shape in a plan view. The peripheral edge portion 62 is located on the first surface 11a at the outer edge portion 11c. The outer edge of the peripheral edge portion 62 matches the outer edge of the substrate 11 in a plan view. The peripheral edge portion 62 is made thin along the outer edge of the outer edge portion 11c. That is, a portion of the peripheral edge portion 62 along the outer edge of the outer edge portion 11c is thinner than the other portion of the peripheral edge portion 62 excluding the portion along the outer edge. In this example, the peripheral edge portion 62 is made thin by removing parts of the polysilicon layer 27 and the silicon nitride layer 28 constituting the second laminated body 24. The peripheral edge portion 62 has a non-thinned portion 62a that is continuous with the covering portion 61 and the thinned portion 62b (refer to FIG. 1) surrounding the non-thinned portion 62a. In the thinned portion 62b, the polysilicon layer 27 and the silicon nitride layer 28 other than the polysilicon layer 27a provided directly on the first surface 11a are removed.

### [Functions and Effects]

As described above, in the Fabry-Perot interference filter 1, the outer end surface of the intermediate layer 23 (more specifically, the outer end surface 53b of the extending portion 53) is covered by the second laminated body 24. Therefore, peeling of the intermediate layer 23 can be suppressed. In addition, the outer edges of a plurality of layers including the polysilicon layer 25c in which the driving electrode 12 is formed, among the layers constituting the first laminated body 22, are covered by the covering portion 52 of the intermediate layer 23. Therefore, since electrical insulation between the polysilicon layer 25c in the first laminated body 22 and the polysilicon layer 27a in which the driving electrode 14 is formed in the second laminated body 24 can be improved, it is possible to suppress current leakage occurring between the driving electrode 12 and the driving electrode 14 through the polysilicon layer 25c and the polysilicon layer 27a. In particular, since not only the polysilicon layer 25c but also the outer edges of the plurality of layers including the polysilicon layer 25c are covered by the covering portion 52, current leakage can be suppressed more reliably. That is, the outer edge of the polysilicon layer 25c can be more reliably covered than in a case where only the outer edge of the polysilicon layer 25c is covered. By suppressing the current leakage, it is possible to avoid a situation in which a high voltage is required to drive the Fabry-Perot interference filter 1 and accordingly it is difficult to use the Fabry-Perot interference filter 1, a situation in which the distance between the first mirror portion 31 and the second mirror portion 32 is not increased to the target value even if a predetermined voltage is applied and accordingly light having a target wavelength cannot be transmitted, and the like. In addition, the intermediate layer 23 has the extending portion 53 that extends outward from the covering portion 52 along the direction parallel to the first surface 11a of the substrate 11, and the second laminated body 24 extends to cover the stepped surface 54, which is formed between the defining portion 51 and the extending portion 53 by the covering portion 52, and the outer end surface 53b of the extending portion 53. Therefore, the step formed in the second laminated body 24 can be made gentler than in a case where the intermediate layer 23 does not have the extending portion 53. That is, when the intermediate layer 23 does not have the extending portion 53, one relatively large step is formed between the second mirror portion 32 and the peripheral edge portion 62 in the second laminated body 24. On the other hand, in the Fabry-Perot interference filter 1, the step formed in the second laminated body 24 is divided into a step formed between the second mirror portion 32 and the second portion 64 by the first portion 63 and a step formed between the second portion 64 and the peripheral edge portion 62 by the third portion 65. By constituting the step stepwise in this manner, the step formed in the second laminated body 24 can be made gentle. By making the step formed in the second laminated body 24 gentle, for example, it is possible to suppress the occurrence of application unevenness when applying the resist for etching. As a result, it is possible to improve the manufacturing stability. More specifically, for example, by suppressing the thinning of the resist due to uneven application, it is possible to secure a large margin of etching time at the edge portion even when dry etching is used. That is, it is possible to prevent a situation in which a portion to be originally prevented from being etched by the resist is etched due to the thinned resist. As a result, it is possible to improve the manufacturing stability. Therefore, according to the Fabry-Perot interference filter 1, it is possible to suppress current leakage and improve the manufacturing stability while suppressing the peeling of each layer on the substrate 11.

The Fabry-Perot interference filter 1 includes the compensation electrode 13 formed in the polysilicon layer 25c. Therefore, since the compensation electrode 13 has the same potential as the driving electrode 14, the first mirror portion and the second mirror portion can be kept flat at the time of driving. In addition, the wiring portion 18 electrically connected to the driving electrode 14 and the compensation electrode 13 is formed in the polysilicon layer 25c, and the outer edge of the polysilicon layer 25c is covered by the covering portion 52. Therefore, current leakage can be suppressed even more reliably.

In the Fabry-Perot interference filter 1, the covering portion 52 covers the outer edges of all the layers constituting the first laminated body 22. Therefore, current leakage can be suppressed even more reliably. In addition, since the outer edges of all the layers constituting the first laminated body 22 are covered by the intermediate layer 23 and the outer edge (outer end surface 53b) of the intermediate layer 23 is covered by the second laminated body 24, the peeling of the first laminated body 22 can be suitably suppressed.

In the Fabry-Perot interference filter 1, the width L1 of the extending portion 53 is larger than the thickness L2 of the defining portion 51. Therefore, the large width L1 of the extending portion 53 can be secured. As a result, it is possible to suitably suppress the peeling of each layer on the substrate 11 and to suitably make a step formed in the second laminated body 24 gentle.

In the Fabry-Perot interference filter 1, the width L1 of the extending portion 53 is larger than the width L3 of the stepped surface 54. Therefore, it is possible to increase the distance between the first portion 63 (that is, a portion that covers the stepped surface 54) and the third portion 65 (that is, a portion that covers the outer end surface 53b of the extending portion 53) of the second laminated body 24. As a result, the step formed in the second laminated body can be made gentle, and the manufacturing stability can be further improved. In addition, the width L1 of the extending portion 53 can be secured larger, and as a result, the peeling of each layer on the substrate 11 can be more suitably suppressed.

In the Fabry-Perot interference filter 1, the stepped surface 54 is a curved surface. Therefore, since the surface 63a of the first portion 63 of the second laminated body 24 becomes smoother, the manufacturing stability can be further improved. In addition, in the Fabry-Perot interference filter 1, the stepped surface 54 is curved in a convex shape. Therefore, since the surface 63a of the first portion 63 of the second laminated body 24 becomes even smoother, the manufacturing stability can be further improved. In addition, in the Fabry-Perot interference filter 1, the outer end surface 22a of the first laminated body 22 is curved in a convex shape. Therefore, since the surface 63a of the first portion 63 of the second laminated body 24 becomes even smoother, the manufacturing stability can be further improved.

In the Fabry-Perot interference filter 1, the driving electrode 14 is formed in the polysilicon layer 27a, which is in contact with the intermediate layer 23, among the layers constituting the second laminated body 24. When the driving electrode 14 is formed in the polysilicon layer 27a, the distance between the layer (polysilicon layer 25c) in which the driving electrode 12 is formed and the layer (polysilicon layer 27a) in which the driving electrode 14 is formed is reduced. According to the Fabry-Perot interference filter 1, even in such a case, it is possible to suitably suppress the occurrence of current leakage.

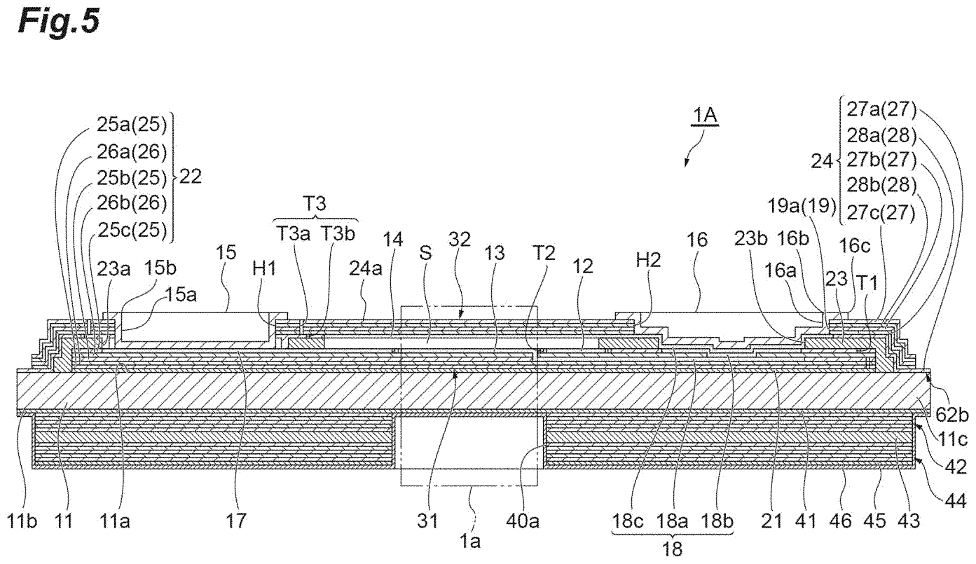

In the Fabry-Perot interference filter 1, the terminal 16 is disposed in the through hole H2 extending from the surface 24a of the second laminated body 24 to the intermediate layer 23, and the intermediate layer 23 has the inner side surface 23b that defines the through hole H2. Then, the opening edge 16b of the opening 16a formed in the terminal 16 is located further inward than the inner side surface 23b (in other words, the center side of the gap S) in a plan view. A contact hole 19 passing through the polysilicon layers 27b and 27c and the silicon nitride layers 28a and 28b is formed in the second laminated body 24. The terminal 16 is electrically connected to the wiring portion 18c formed in the polysilicon layer 27a through the contact hole 19. An edge 19a of the contact hole 19 is located further inward than the inner side surface 23b of the intermediate layer 23 over the entire circumference in a plan view. Therefore, the manufacturing stability can be further improved. Hereinafter, the reason will be described with reference to FIG. 5.

In a Fabry-Perot interference filter 1A of a first modification example illustrated in FIG. 5, the opening edge 16b of the opening 16a is located further outward than the inner side surface 23b over the entire circumference in a plan view. The edge 19a of the contact hole 19 is located further outward than the inner side surface 23b of the intermediate layer 23 over the entire circumference in a plan view. In the manufacturing process of such a Fabry-Perot interference filter 1A, etching residue may be generated when the opening 16a and the contact hole 19 are formed by dry etching. On the other hand, in the Fabry-Perot interference filter 1 of the embodiment described above, even when the opening 16a and the contact hole 19 are formed by dry etching, the generation of etching residue can be suppressed. Therefore, the manufacturing stability can be further improved. In addition, also by the Fabry-Perot interference filter 1A of the first modification example, it is possible to suppress current leakage and improve the manufacturing stability while suppressing the peeling of each layer on the substrate 11 as in the Fabry-Perot interference filter 1 of the embodiment described above.

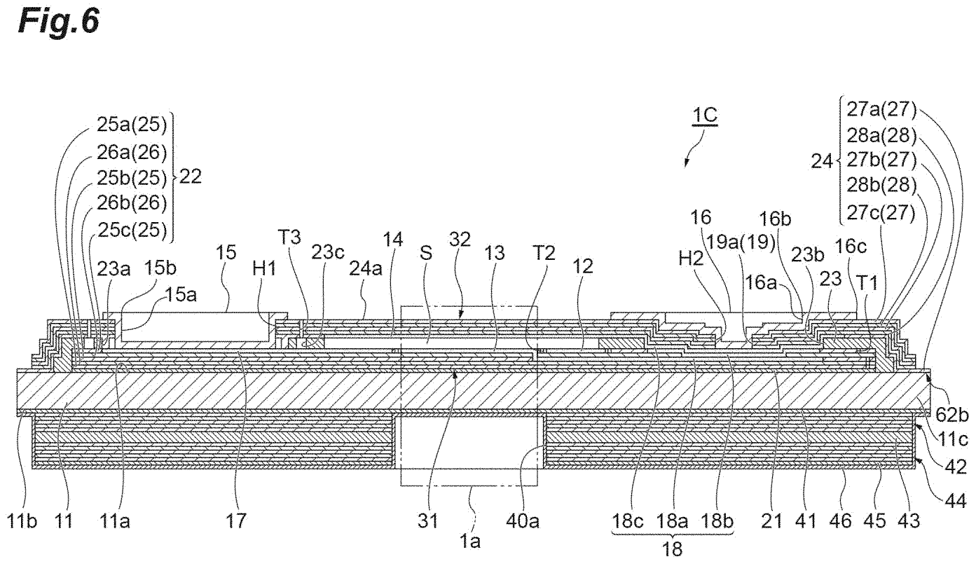

In the Fabry-Perot interference filter 1, the trench T3 that is formed in the second laminated body 24 and extends to surround the terminal 15 has the first portion T3a, which is continuously formed in the polysilicon layers 27b and 27c and the silicon nitride layers 28a and 28b, and the second portion T3b, which is formed in the polysilicon layer 27a and is separated from the first portion T3a. Therefore, the stability of the intermediate layer 23 can be improved. Hereinafter, the reason will be described with reference to FIG. 6.

In a Fabry-Perot interference filter 1C of a second modification example illustrated in FIG. 6, the trench T3 is configured by one portion continuously formed in the polysilicon layers 27a, 27b, and 27c and the silicon nitride layers 28a and 28b. A hole 23c continuous with the trench T3 is formed in the intermediate layer 23. The hole 23c passes through the intermediate layer 23. The hole 23c is formed when a part of the intermediate layer 23 is removed by etching using a through hole formed in the second laminated body 24 to form the gap S. When such a hole 23c is formed, the stability of the intermediate layer 23 is degraded, and damage is likely to occur. For example, when damage occurs and debris or the like is scattered, the optical characteristics may be degraded or the yield may be reduced. On the other hand, in the Fabry-Perot interference filter 1 described above, the trench T3 is divided into the first portion T3a continuously formed in the polysilicon layers 27b and 27c and the silicon nitride layers 28a and 28b and the second portion T3b formed in the polysilicon layer 27a and separated from the first portion T3a. Therefore, since it is possible to prevent the hole 23c from being formed in the intermediate layer 23 when constituting the gap S, the stability of the intermediate layer 23 can be improved. As a result, it is possible to suppress the degradation of the optical characteristics or a reduction in yield due to debris. In addition, also by the Fabry-Perot interference filter 1B of the second modification example, it is possible to suppress current leakage and improve the manufacturing stability while suppressing the peeling of each layer on the substrate 11 as in the Fabry-Perot interference filter 1 of the embodiment described above.

Although an embodiment of the present disclosure has been described above, the present disclosure is not limited to the above embodiment. In the embodiment, the first modification example, and the second modification example described above, the covering portion 52 covers the outer edges of all the layers constituting the first laminated body 22. However, the covering portion 52 may cover the outer edges of a plurality of layers including the polysilicon layer 25c in which the driving electrode 12 is formed among the layers constituting the first laminated body 22. For example, the covering portion 52 may cover only the outer edges of the polysilicon layer 25c and the silicon nitride layer 26b, and may not cover the outer edges of the polysilicon layers 25a and 25b and the silicon nitride layer 26a. In this case, the polysilicon layers 25a and 25b and the silicon nitride layer 26a may extend between the first surface 11a and the extending portion 53. The covering portion 52 may cover only the outer edges of the polysilicon layers 25c and 25b and the silicon nitride layer 26b.

In the embodiment, the first modification example, or the second modification example described above, the stepped surface 54 may be curved in a concave shape. The stepped surface 54 may not be curved or may be a flat surface. The stepped surface 54 may not extend to be inclined with respect to the first surface 11a, or may be a flat surface perpendicular to the first surface 11a. The outer end surface 22a of the first laminated body 22 may be curved in a concave shape. The outer end surface 22a may not be curved or may be a flat surface. The outer end surface 22a may not extend to be inclined with respect to the first surface 11a, or may be a flat surface perpendicular to the first surface 11a. The outer end surface 53b of the extending portion 53 may be curved in a convex shape. The outer end surface 53b may not be curved or may be a flat surface. The outer end surface 53b may not extend to be inclined with respect to the first surface 11a, or may be a flat surface perpendicular to the first surface 11a.

In the embodiment, the first modification example, or the second modification example described above, the driving electrode 12 may be formed in a layer other than the polysilicon layer 25c among the layers constituting the first laminated body 22. That is, the driving electrode 12 may be formed in a layer other than a layer in contact with the intermediate layer 23 (a layer facing the gap S). In this case, the driving electrode 12 faces the driving electrode 14 with another layer constituting the first laminated body 22 interposed therebetween. The driving electrode 14 may be formed in a layer other than the polysilicon layer 27a among the layers constituting the second laminated body 24. That is, the driving electrode 14 may be formed in a layer other than a layer in contact with the intermediate layer 23 (a layer facing the gap S). In this case, the driving electrode 14 faces the driving electrode 12 with another layer constituting the second laminated body 24 interposed therebetween. The compensation electrode 13 may be formed in a layer other than the polysilicon layer 25c among the layers constituting the first laminated body 22. The third electrode may be used not as a compensation electrode but as a monitoring electrode for monitoring the state of the Fabry-Perot interference filter 1. In this case, the third electrode does not have to be electrically connected to the driving electrode 14.

In the embodiment, the first modification example, or the second modification example described above, the peripheral edge portion 62 may be made thin by removing all of the polysilicon layer 27 and the silicon nitride layer 28 at the thinned portion 62b. The peripheral edge portion 62 may not be made thin along the outer edge of the outer edge portion 11c. The third laminated body 42, the intermediate layer 43, and the fourth laminated body 44 may be made thin by removing a part of each layer in a region overlapping the thinned portion 62b when viewed from a direction perpendicular to the first surface 11a. The third laminated body 42, the intermediate layer 43, and the fourth laminated body 44 may not be made thin along the outer edge of the outer edge portion 11c. The Fabry-Perot interference filter 1 may not include the compensation electrode 13. The Fabry-Perot interference filter 1 may not include a laminated structure (antireflection layer 41, third laminated body 42, intermediate layer 43, fourth laminated body 44, light shielding layer 45, and protective layer 46) provided on the second surface 11b of the substrate 11. For example, the material and shape of each component are not limited to the materials and shapes described above, and various materials and shapes can be adopted.

### REFERENCE SIGNS LIST

1: Fabry-Perot interference filter, 11: substrate, 11a: first surface, 12: driving electrode (first electrode), 13: compensation electrode (third electrode), 14: driving electrode (second electrode), 18: wiring portion, 22: first laminated body, 22a: outer end surface, 23: intermediate layer, 24: second laminated body, 25b: polysilicon layer (third layer), 25c: polysilicon layer (first layer), 27a: polysilicon layer (second layer), 31: first mirror portion, 32: second mirror portion, 51: defining portion, 52: covering portion, 53: extending portion, 53b: outer end surface, 54: stepped surface, S: gap.

1: A Fabry-Perot interference filter, comprising:
a substrate including a first surface;
a first laminated body including a first mirror portion disposed on the first surface;
a second laminated body including a second mirror portion that faces the first mirror portion with a gap interposed therebetween on a side opposite to the substrate with respect to the first mirror portion;
an intermediate layer including a defining portion that defines the gap between the first laminated body and the second laminated body;
a first electrode formed in a first layer constituting the first laminated body; and
a second electrode that is formed in a second layer constituting the second laminated body and faces the first electrode,
wherein the intermediate layer further includes:
a covering portion that covers outer edges of a plurality of layers including the first layer among layers constituting the first laminated body; and
an extending portion that extends outward from the covering portion along a direction parallel to the first surface, and
the second laminated body extends to cover a stepped surface formed between the defining portion and the extending portion by the covering portion and an outer end surface of the extending portion.

2: The Fabry-Perot interference filter according to claim 1, further comprising:
a third electrode that is formed in the first laminated body and faces the second electrode; and
a wiring portion that is formed at least in a third layer constituting the first laminated body and is electrically connected to the second electrode and the third electrode,
wherein the covering portion further covers an outer edge of the third layer.

3: The Fabry-Perot interference filter according to claim 1,
wherein the covering portion covers outer edges of all layers constituting the first laminated body.

4: The Fabry-Perot interference filter according to claim 1,
wherein a width of the extending portion is larger than a thickness of the defining portion.

5: The Fabry-Perot interference filter according to claim 1,
wherein the stepped surface extends to be inclined with respect to the first surface, and
a width of the extending portion is larger than a width of the stepped surface.

6: The Fabry-Perot interference filter according to claim 1,
wherein the stepped surface is a curved surface.

7: The Fabry-Perot interference filter according to claim 6,
wherein the stepped surface is curved in a convex shape.

8: The Fabry-Perot interference filter according to claim 1,
wherein an outer end surface of the first laminated body is curved in a convex shape.

9: The Fabry-Perot interference filter according to claim 1,
wherein the second layer is a layer in contact with the intermediate layer among layers constituting the second laminated body.
